(19) United States
(12) Patent Application Publication
(10) Pub. No.: US 2023/0244885 A1
(43) Pub. Date: Aug. 3, 2023

(54) DEVICE AND METHOD FOR PACKAGING AND STORING VALUABLE ARTICLES WITH ANTI-COUNTERFEITING FUNCTION

(71) Applicant: Lien Hao Chuang, Kaohsiung (TW)

(72) Inventor: Lien Hao Chuang, Kaohsiung (TW)

(21) Appl. No.: 17/861,857

(22) Filed: Jul. 11, 2022

(30) Foreign Application Priority Data
Jan. 28, 2022 (TW) 111104215

(51) Int. Cl. G06K 7/10; B65D 55/02; B65D 43/02; B65D 6/06

(52) U.S. Cl. CPC G06K 7/10366; B65D 55/026; B65D 43/0254; B65D 11/12; B65D 43/0256; B65D 2543/00203; B65D 2543/00518; B65D 2543/00537; B65D 2543/0062; B65D 2543/0074

(57) ABSTRACT

A device and a method for packaging and storing valuable articles with anti-counterfeiting function, wherein a reader transmits an induction signal to a carrier that accommodates a valuable article. When a wireless communication element disposed on the valuable article transmits the identification information stored by itself when receiving the induction signal. When a communication unit disposed on the carrier receives the identification information, a processing unit analyses the identification information and presents the analyzed identification information through a display unit. In this way, users can directly know the information of the valuable article, thereby identifying the authenticity of the valuable article. In addition, the wireless communication element and a box for accommodating the carrier have a structure to prevent damage. When they are removed by external force, the original state cannot be restored.

### BACKGROUND OF INVENTION

### (1) Field of the Present Disclosure

The present disclosure relates to a device and a method for packaging and storing valuable articles with anti-counterfeiting function, in particular to a device and a method employing radio frequency identification technology and structure to achieve the anti-counterfeiting effect and to prevent damage.

### (2) Brief Description of Related Art

With the gradual transformation of physical stores into online shopping platforms, consumers can already buy luxury articles, such as gold, diamonds, jewelry and other high-priced items on major e-commerce platforms. However, due to the prevalence of online shopping, knock-off or high-quality imitation articles are becoming more and more popular. Therefore, consumers may be deceived into buying fake articles.

At present, the method for identifying luxury articles in the market mainly uses appraisal certificates, quality assurance certificates, or engraving codes on the articles themselves to identify the article authenticity. However, when luxury articles are traded, paper certificates are not only easy to lose, but also more easily counterfeited, which cannot effectively guarantee the authenticity of luxury articles. Accordingly, how to allow consumers to quickly identify the authenticity of the goods without going through paper documents when trading luxury goods is a problem to be solved.

### SUMMARY OF INVENTION

It is a primary object of the present disclosure to provide a device and a method for packaging and storing valuable articles with anti-counterfeiting function that allows consumers to quickly identify the product authenticity when they trade luxury goods.

According to the present disclosure, a valuable article can be accommodated in a device of the present disclosure. Meanwhile, the device includes a carrier with a circuit board and a power supply unit, and a wireless communication element attached to the valuable article or embedded in the carrier. When the user sends an induction signal to the carrier accommodating the valuable article through a reader, the wireless communication element can receive the induction signal and send an identification information stored by itself. Thereafter, the identification information is received by a communication unit arranged on the circuit board, and then analyzed by a processing unit. Finally, the analyzed identification information is displayed through a display unit.

In addition, the device according to the present disclosure can also be further assembled in a box. A first pre-break line or a second pre-break line is formed in the structure of the box. When the box is damaged by external force, the structure breaks along each pre-break line, so as to confirm the integrity of the box. In addition, the wireless communication element also has a tearing line. When the wireless communication element is removed by external force, the wireless communication element is divided into a connection part and a circuit part along the tearing line. In this way, the wireless communication element cannot be reattached to the valuable article in a complete state.

### BRIEF DESCRIPTION OF THE DRAWINGS

FIG. 1 is a perspective view I of a storage device according to the present disclosure;

FIG. 2 is a perspective view of an embodiment of the storage device according to the present disclosure;

FIG. 3 is a schematic drawing I of the partial structure of the present disclosure;

FIG. 4 is a perspective view II of the storage device according to the present disclosure;

FIG. 5 is an exploded view of the storage device according to the present disclosure;

FIG. 6 is a schematic drawing II of the partial structure of the present disclosure;

FIG. 7 is a schematic drawing III of the partial structure of the present disclosure;

FIG. 8 is a perspective view of another embodiment of the storage device according to the present disclosure;

FIG. 9 is a perspective view of a further embodiment of the storage device according to the present disclosure;

FIG. 10 is an implementation view of the present disclosure; and

FIG. 11 is a flow chart of the method according to the present disclosure.

### DETAILED DESCRIPTION OF PREFERRED EMBODIMENTS

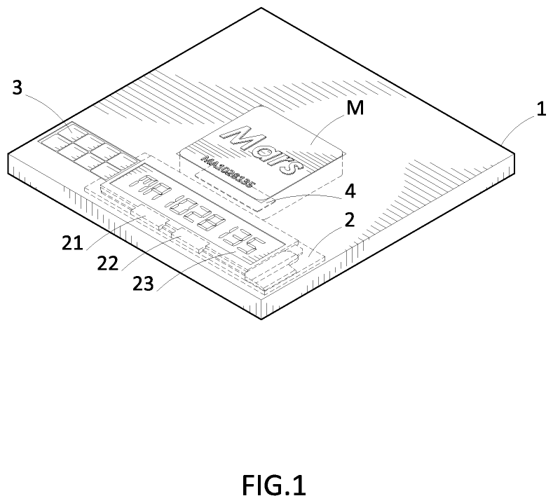

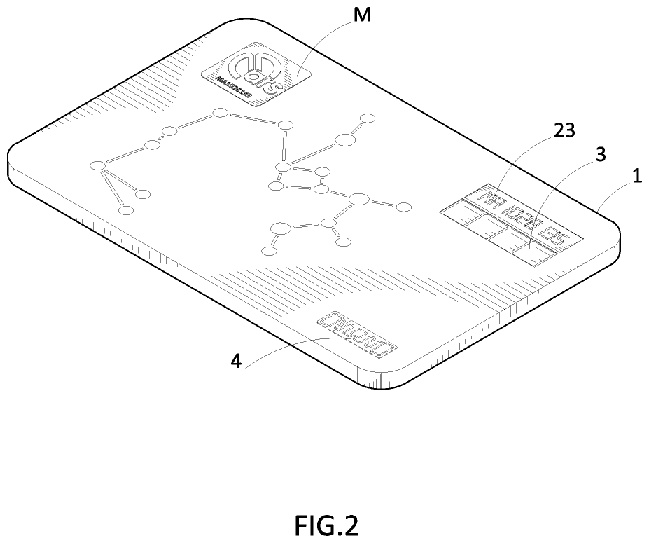

Referring to FIG. 1, a device for packaging and storing valuable articles with anti-counterfeiting function includes a carrier 1. A plurality of grooves is formed on a surface of the carrier 1. Each groove is respectively used for accommodating a valuable article M, a circuit board 2, and a power supply unit 3. The carrier 1 can be a sheet-like object, a box, or a container with a thickness or a depth. Preferably, the carrier 1 (see FIG. 2) can be a card made of plastic, glass, or other transparent materials. The circuit board 2 is provided with a communication unit 21, a processing unit 22, and a display unit 23. The processing unit 22 includes a processor and a memory. The processor can access a specific instruction code from the memory and execute an application program defined by a specific instruction code. The aforementioned application program is mainly selected from a group consisting of: an application program that enables the communication unit 21 to communicate with other devices, an application program that enables the processing unit 22 to analyze and convert data, and an application program that enables the display unit 23 to present data, etc. In addition, the processing unit 22 can be one or a combination of Central Processing Unit (CPU), Graphics Processing Unit (GPU), Micro Processing Unit (MPU), Digital Signal Processor (DSP), Micro Control Unit (MCU), etc. The power supply unit 3 can be one or more solar panels, low-light power generation, photovoltaic devices, lithium batteries, mercury batteries, or other components that can supply power to the circuit board 2.

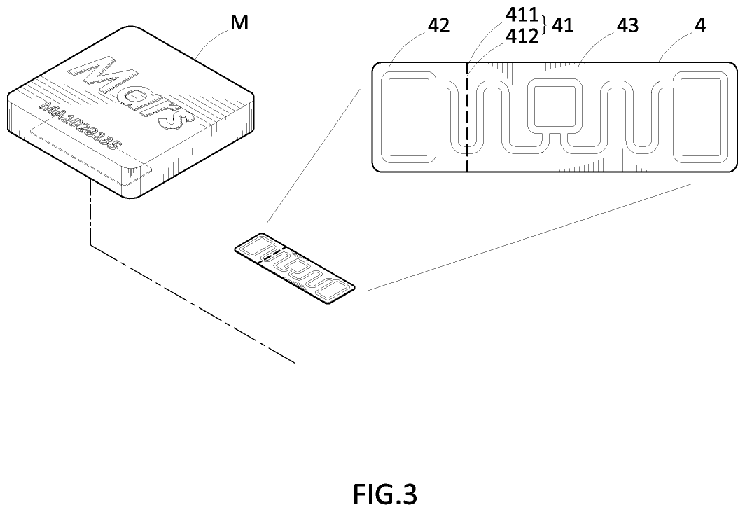

Referring to FIG. 3 together with FIG. 1 and FIG. 2, a wireless communication element 4 can be attached to a surface of the valuable article M or embedded in the carrier 1. The wireless communication element 4 can be an electronic tag of Radio Frequency Identification (RFID) or Near Field Communication (NFC) storing an identification information of the valuable article M. The identification information can be one or a combination of item number, item origin, item weight, item transaction record, etc. The valuable article M can be gold, commemorative coins, pearls, jade, or small collectibles, etc. It is understood that the valuable article M is not limited thereto. In a few embodiments, the wireless communication element 4 includes a tearing line 41. The tearing line 41 is composed of a plurality of disconnecting slits 411 and a plurality of connecting parts 412 with low-strength structure. When the wireless communication element 4 is removed by an external force, the wireless communication element 4 is split into a connection part 42 and a circuit part 43 according to the tearing line 41. In this way, the wireless communication element 4 cannot be reattached to the valuable article M in a complete state, thereby allowing the user to achieve the purpose of identifying the authenticity of the article.

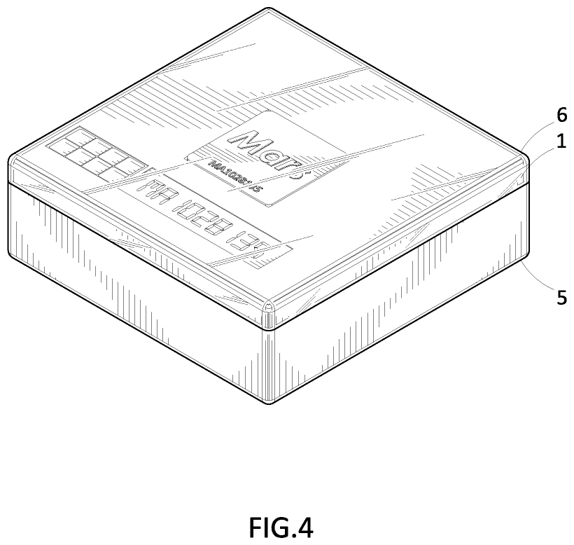

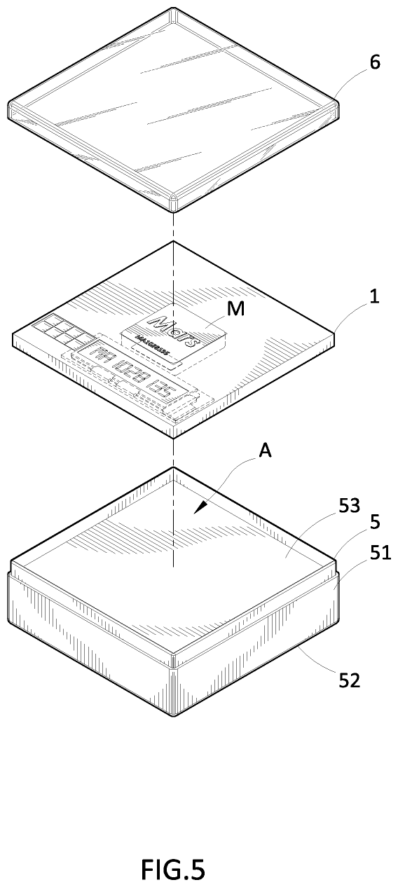

As shown in FIG. 4 and FIG. 5, the device for packaging and storing valuable articles with anti-counterfeiting function further includes a box 5 and an outer cover 6 corresponding to the box 5 for fixing and protecting the valuable article M. The box 5 includes a plurality of side wall 51, a bottom wall 52, and a top wall 53. One end of each side wall 51 extends relative to the bottom wall 52 and protrudes beyond the top wall 53, thereby defining an accommodating space A on the outer surface of the top wall 53 for accommodating the carrier 1. In some embodiments, the height of the accommodating space A is not greater than the thickness of the carrier 1. In other embodiments, the height of the accommodating space A is not less than the thickness of the carrier 1.

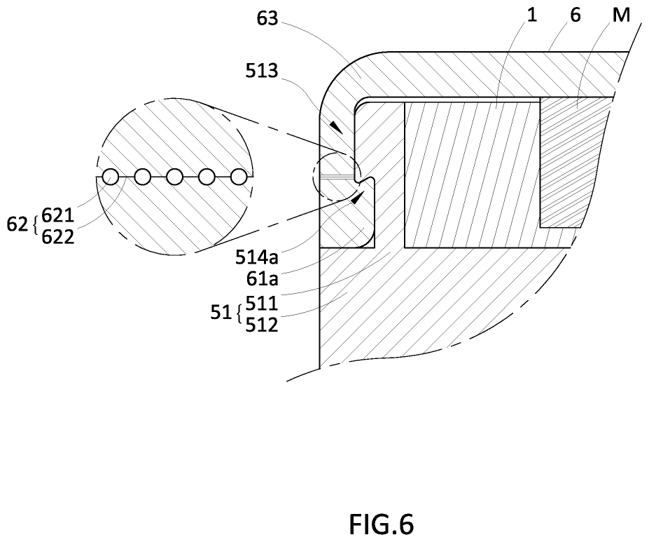

Referring to FIG. 6, in some embodiments, each side wall 51 can be divided into an inner side wall 511 and an outer side wall 512. The inner side wall 511 is higher than the outer side wall 512 to form a difference step 513. A groove 514a is formed near the top wall 53 in the difference step 513 such that a snap portion 61a of the outer cover 6 snaps into the groove 514a. In this way, since the height of the accommodating space A is not greater than the thickness of the carrier 1, that is, the height of the inner side wall 511 is less than the thickness of the carrier 1, the outer cover 6 can abut against the carrier 1, thereby fixing and protecting the valuable article M. In other embodiments, the outer cover 6 is formed with a first pre-break line 62 adjacent to the snap portion 61a. The first pre-break line 62 is formed by a plurality of disconnecting slits 621 and a plurality of connecting parts 622 with low-strength structures. When the outer cover 6 is removed by an external force, the outer cover 6 is split into the snap portion 61a and a cover portion 63 along the first pre-break line 62 such that the outer cover 6 cannot be reconnected to the box 5 in its complete state, thereby preventing disassembly and damage of the article so as to achieve the purpose of identifying the authenticity of the article.

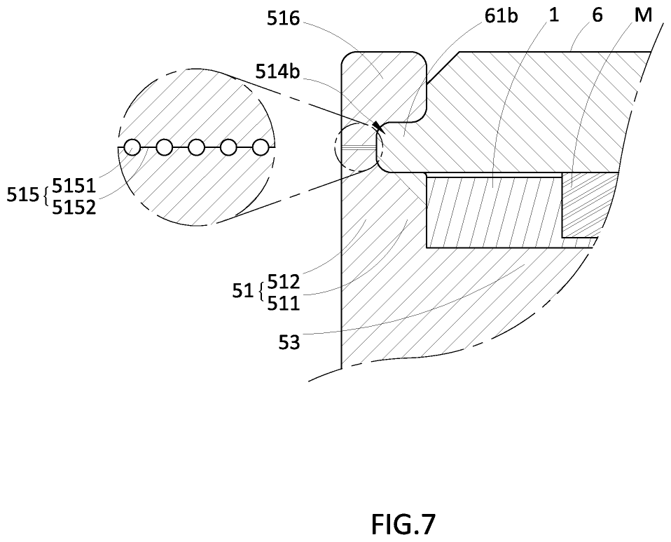

Referring to FIG. 7, in some embodiments, another groove 514b is formed in the inner side wall 511 adjacent to the top wall 53 for the corresponding snap-fit of the snap portion 61b of the outer cover 6. In this way, since the height of the accommodating space A is not greater than the thickness of the carrier 1, that is, the height of the outer side wall 512 is greater than the thickness of the carrier 1, the outer cover 6 can abut against the carrier 1, thereby fixing and protecting the valuable article M. In other embodiments, the outer side wall 512 is formed with a second pre-break line 515 adjacent to the groove 514b. The second pre-break line 515 is formed by a plurality of disconnecting slits 5151 and a plurality of connecting parts 5152 with low-strength structures. When the side wall 51 is removed by an external force, the side wall 51 is split into the snap portion 61b and a connection portion 516 along the second pre-break line 515 such that the outer cover 6 cannot be reconnected to the box 5 in its complete state, thereby preventing disassembly and damage of the article so as to achieve the purpose of identifying the authenticity of the article.

In some embodiments, the grooves 514a and 514b can be simultaneously formed on both sides of the inner side wall 511 for corresponding snap fit of the different snap parts 61a and 61b. Meanwhile, in some embodiments, the outer cover 6 can be made of a transparent material such as plastic or glass, or has one or more observation areas such that the user can directly view the valuable article M through the outer cover 6. In some embodiments, the snap portion 61 can be one of a strip-shaped protrusion or a plurality of round protrusions or a combination thereof, thereby forming an S-shaped connection with the grooves 514a and 514b.

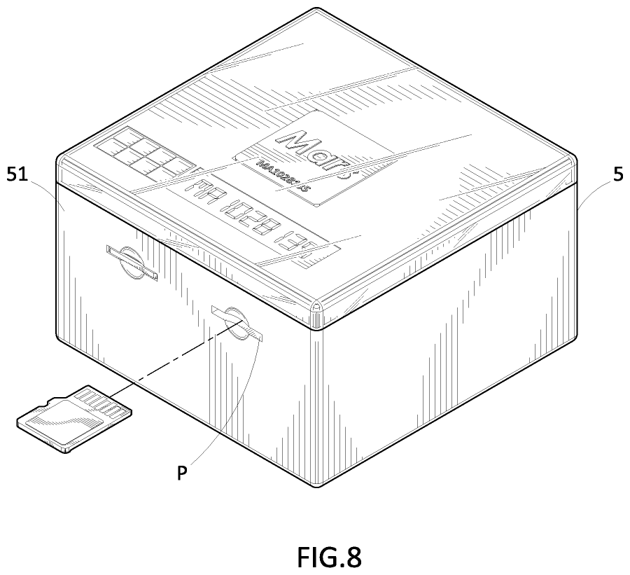

As shown in FIG. 8, one of the side walls 51 of the box 5 has a plurality of ports P for electrically connecting a plurality of memory cards. The memory card can store one or a combination of multimedia information such as identification, blessing text, pictures, images, etc., but not limited thereto. In some embodiments, one end of the port P can be electrically connected to the circuit board, so that the processing unit can transmit the multimedia information in the memory card to the display unit for presentation.

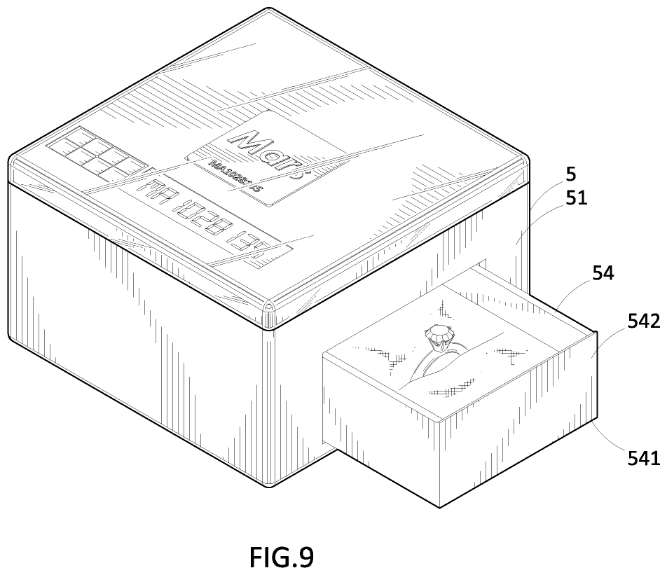

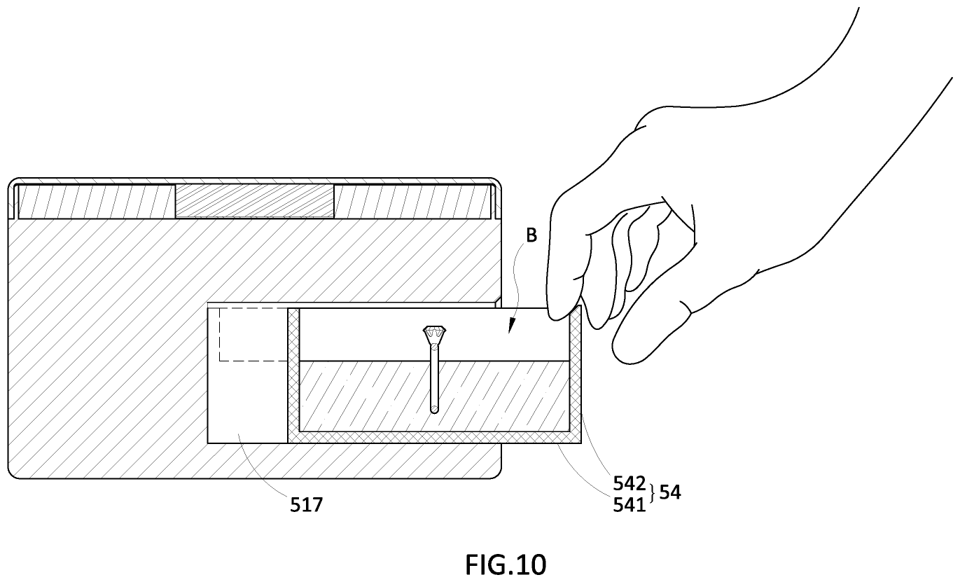

Referring to FIG. 9 and FIG. 10, one of the side walls 51 of the box 5 has a slot 517 in which a sliding member 54 fits. The sliding member 54 includes a bottom plate 541 and a plurality of side plates 542 which defines a storage space B in the box 5 for placing rings, necklaces, jade, pearls, commemorative coins, or smaller ornaments, etc. One of the side plates 542 can be a front plate by which the slot 517 is opened and closed. One end of the side plate 542 opposite to the bottom plate 541 includes a gradient inclined from the outside to the inside, so that the user can easily open the storage space B by applying force to the inclined gradient.

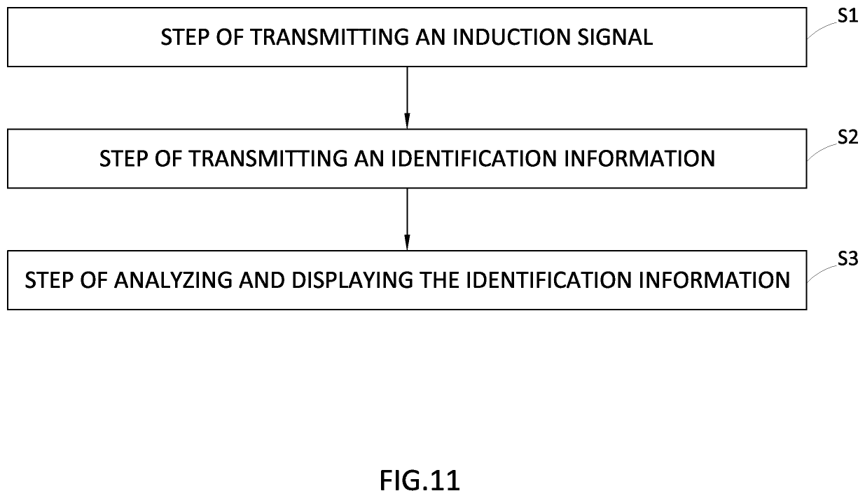

Referring to FIG. 11, a method for packaging and storing valuable articles with anti-counterfeiting function includes the following steps:

Step S1 of transmitting an induction signal: The user can transmit an induction signal to the carrier 1 containing the valuable article M through a reader. The reader can be a mobile phone, a computer, an RFID reader, or other mobile electronic devices that can sense electronic tags. Preferably, the user can send the induction signal through an Application (APP) in the mobile phone;

Step S2 of transmitting the identification information: when the wireless communication element 4 disposed on the valuable article M transmits the identification information stored by itself when receiving the induction signal.

Step S3 of analyzing and displaying the identification information S3: the communication unit 21 disposed on the carrier 1 and arranged on the circuit board 2 receives the identification information. Then, the processing unit 22 arranged on the circuit board 2 analyzes the identification information through a specific command code. Finally, the analyzed identification information is displayed by the display unit 23 disposed on the circuit board 2. In this way, the user can obtain the information of the valuable article M from the display unit 23, thereby achieving the purpose of identifying the authenticity of the article. In some embodiments, the identification information can also be received by the reader held by the user, so that the user can make a check through comparison with the identification information presented by the display unit 23

According to the present disclosure, the reader is mainly used to transmit an induction signal to the carrier that accommodates the valuable article. When the wireless communication element disposed on the valuable article receives the induction signal, it transmits the identification information stored by itself. When a communication unit disposed on the carrier receives the identification information, the processing unit analyzes the identification information and presents the analyzed identification information through the display unit. In this way, the user can directly know the information of the valuable article, thereby identifying the authenticity of the valuable article. It is possible through the present disclosure to provide a way for consumers to quickly identify the authenticity of articles without going through paper documents when trading luxury articles.

### REFERENCE SIGN

1 carrier
2 circuit board
21 communication unit
22 processing unit
23 display unit
3 power supply unit
4 wireless communication element
41 tearing line
411 slit
412 connecting part
42 connection part
43 circuit part
5 box
51 side wall
511 inner side wall
512 outer side wall
513 difference step
514a, 514b groove
515 second pre-break line
5151 disconnecting slit
5152 connection part
516 connection portion
517 slot
52 bottom wall
53 top wall
54 sliding member
541 bottom plate
542 side plate
6 outer cover
61a, 61b snap portion
62 first pre-break line
621 disconnecting slit
622 connecting part
63 cover portion
S1 step of transmitting an induction signal
S2 step of transmitting identification information
S3 step of analyzing and displaying the identification information
A accommodating space
B storage space
P port
M valuable article

What is claimed is:

1. A device for packaging and storing a valuable article with anti-counterfeiting function, comprising:
a carrier having a plurality of grooves for accommodating the valuable article, a circuit board, and a power supply unit for providing power to the circuit board; and
a wireless communication element with an identification information disposed on a surface of the valuable article; and
the circuit board having a communication unit, a processor, and a display unit, and wherein the communication unit is in information connection with the wireless communication element, and wherein, when the communication unit receives the identification information, the processor analyzes the identification information, whereupon the analyzed identification information is displayed through the display unit.

2. The device for packaging and storing the valuable article with anti-counterfeiting function as claimed in claim 1, wherein the box comprises a plurality of side wall, a bottom wall, and a top wall, and wherein each of the side walls extends relative to the bottom wall and protrudes beyond the top wall, thereby defining an accommodating space on the outer surface of the top wall for accommodating the carrier.

3. The device for packaging and storing the valuable article with anti-counterfeiting function as claimed in claim 2, wherein each of the side walls is divided into an inner side wall and an outer side wall, and wherein a difference step is formed between the inner side wall and the outer side wall, and wherein a groove is formed in the difference step such that a snap portion of the outer cover snaps into the groove.

4. The device for packaging and storing the valuable article with anti-counterfeiting function as claimed in claim 3, wherein the outer cover is formed with a first pre-break line adjacent to the snap portion, and wherein, when the outer cover is removed by an external force, it breaks along the first pre-break line such that the outer cover is separated from the box.

5. The device for packaging and storing the valuable article with anti-counterfeiting function as claimed in claim 3, wherein the snap portion is one or a combination of a strip-shaped protrusion or a plurality of round protrusions, thereby forming an S-shaped connection with the groove.

6. The device for packaging and storing the valuable article with anti-counterfeiting function as claimed in claim 2, wherein each of the side walls is divided into an inner side wall and an outer side wall, and wherein a groove is formed in the inner side wall such that a snap portion of the outer cover snaps into the groove.

7. The device for packaging and storing the valuable article with anti-counterfeiting function as claimed in claim 6, wherein the outer side wall is formed with a second pre-break line adjacent to the groove, and wherein, when the side wall is removed by an external force, it breaks along the first pre-break line such that the box is separated from the outer cover.

8. The device for packaging and storing the valuable article with anti-counterfeiting function as claimed in claim 6, wherein the snap portion is one or a combination of a strip-shaped protrusion or a plurality of round protrusions, thereby forming an S-shaped connection with the groove.

9. The device for packaging and storing the valuable article with anti-counterfeiting function as claimed in claim 1, wherein one of the side walls has a plurality of ports for electrically connecting a plurality of memory cards, and wherein the ports are electrically connected to the circuit board, so that the processing unit can transmit the multimedia information in the memory cards to the display unit for presentation.

10. The device for packaging and storing the valuable article with anti-counterfeiting function as claimed in claim 1, wherein one of the side walls includes a slot in which a sliding member fits, and wherein the sliding member comprises a bottom plate, a plurality of side plates, and a storage space, and wherein one end of the side plate opposite to the bottom plate includes a gradient inclined from the outside to the inside for opening the storage space.

11. A method for packaging and storing a valuable article with anti-counterfeiting function for assisting a user to directly distinguish the authenticity of a valuable article, comprising steps of:
transmitting an induction signal to a carrier accommodating the valuable article through a reader;
when a wireless communication element disposed on the valuable article transmits an identification information stored by itself when receiving the induction signal;
receiving the identification information by a communication unit disposed on the carrier, and analyzing the identification information through a processing unit of the carrier; and
displaying the identification information through a display unit.

12. The method for packaging and storing the valuable article with anti-counterfeiting function as claimed in claim 11, wherein the reader is one of a mobile phone, a computer, or an RFID reader/writer.
